(19) United States
(12) Patent Application Publication
(10) Pub. No.: US 2025/0190360 A1
(43) Pub. Date: Jun. 12, 2025

(54) OS-TRANSPARENT MEMORY DECOMPRESSION WITH HARDWARE ACCELERATION

(71) Applicant: Intel Corporation, Santa Clara, CA (US)

(72) Inventors: Stijn EYERMAN, Evergem (BE); Wim HEIRMAN, Aalter (BE); Vinodh GOPAL, Westborough, MA (US); Wajdi FEGHALI, Boston, MA (US)

(21) Appl. No.: 19/049,751

(22) Filed: Feb. 10, 2025

(51) Int. Cl. G06F 12/1009

(52) U.S. Cl. CPC G06F 12/1009; G06F 2212/401

(57) ABSTRACT

Methods and apparatus for Operating System (OS)-transparent memory decompression with hardware acceleration. A physical address space for system memory is partitioned into compressed and uncompressed partitions. A core issues a memory Read request and on-chip L1, L2, and a last level cache (LLC) are checked, with misses leading to page table lookups to determine where in system memory the requested data are stored. When stored in the compressed partition, a compressed page table is searched to find the location of the compressed form of the data on a memory device. The compressed data are read from the memory device, decompressed using hardware acceleration and returned to the requesting core without writing the data to the uncompressed partition. Under one approach, a compressed page containing the requested data is decompressed and written to the LLC. When data (e.g., cache lines) in the decompressed page in the LLC are written to, the decompressed page is evicted from the LLC and written to the uncompressed partition.

### BACKGROUND INFORMATION

Memory compression enables storing more data in a given memory capacity. Hardware (de) compression accelerators reduce the latency of accessing compressed data. However, current solutions (ZSWAP, ZRAM) cause a page fault on access to compressed data, adding operating system (OS) overhead to decompression operations. This increases the latency to access compressed data, which decreases performance if a large part of the data is compressed, which in practice limits the size of the compressed memory partition. Furthermore, low parallelism in handling page faults prevents the accelerators from using their full bandwidth. Decompression at lower overhead and higher bandwidth would enable more compressed data, increasing the capacity gains of memory compression.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of an architecture illustrating selective components of the OS transparent decompression scheme, according to one embodiment;

FIG. 2 is a schematic diagram illustrated selected hardware components of an exemplary computing platform, according to one embodiment;

FIG. 3 is schematic diagram illustrating an SoC implementing a memory coherency architecture employed by the embodiment of FIG. 2;

FIG. 4 is a flowchart illustrating operations and logic performed for a Read request to access data, according to one embodiment;

FIG. 5 is a flowchart illustrating operations performed to service a memory Write request that is to be written to memory in the compressed partition;

FIG. 6 is schematic diagram illustrating a system including a System-on-Package (SoP) having circuitry configured to implement aspects of the embodiments disclosed herein.

### DETAILED DESCRIPTION

Embodiments of methods and apparatus for Operating System (OS)-transparent memory decompression with hardware acceleration are described herein. In the following description, numerous specific details are set forth to provide a thorough understanding of embodiments. One skilled in the relevant art will recognize, however, that the teachings disclosed herein can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

With quickly growing data set sizes (e.g., large databases, large AI models, etc.), memory has become an important component of performance, energy and cost. Compressed memory enables storing more data on the same memory capacity, reducing the memory cost and saving energy by storing and moving data in compressed format. However, it comes with a performance overhead, because data needs to be decompressed before it can be used. To address these issues, some recent and future processors, such as Intel® Xeon® and client systems include compression accelerators (In-Memory Analytics Accelerator (IAA)) that significantly reduce the (de) compression latency versus software (de) compression.

Because accessing compressed memory requires an additional decompression operation, it cannot follow the conventional memory access hardware flow that is implemented in current processors. Therefore, current commercial memory compression implementations (e.g., ZSWAP and ZRAM) use page faults and the operating system (OS) to support memory compression. Data in compressed space is not mapped in the page table (PT), generating a page fault interrupt to the OS when accessed. The OS then looks up the compressed data, performs the decompression (either in software or hardware) and maps the decompressed page to the page table. It also puts the decompressed page in plain (decompressed) DRAM, where it can be accessed in the future without decompression overhead.

This scheme requires that there is some reserved space in plain DRAM to store compressed pages. To ensure enough space, the OS regularly scans pages in plain DRAM, and compresses cold pages (that are not recently touched, and thus unlikely to be touched soon) to move to compressed DRAM, leaving space for future decompressions. Ideally, this is done in the background, with no overhead for the running application. However, if the OS is unable to free space quickly enough, and no space is left to put the decompressed page of the current access, it first needs to migrate another page to compressed space, further increasing the latency of accessing compressed data.

Because of this significant overhead, compressed memory is used for data that is accessed very rarely, such as memory-mapped files or administration data (profiling, logging; also called “datacenter memory tax”), and not for data that is actively used by the application. As a result, only a small fraction of memory is used for compression, limiting its capacity gain potential. For example, assuming a compression factor of 5, a 100 GB memory with 20% used for compression maps to 80 GB+5×20 GB=180 GB of available memory space, a 1.8× capacity gain. However, if we use 50% for compression, the available space becomes 50 GB+5×50 GB=300 GB, a 3× gain. Reducing the overhead of accessing compressed memory will enable more compressed data, increasing the available capacity without increasing the physical memory size.

In accordance with aspects of the embodiments disclosed herein, an OS-transparent decompression scheme for read operations to compressed memory is provided. The decompression scheme avoids the OS page fault overhead, which improves access latency and enables a larger compressed memory size. To limit the hardware overhead and minimize changes to the existing infrastructure, the OS is still responsible for maintaining page tables, migrating pages between compressed and uncompressed space and (re) compression of pages that have been written to.

The memory subsystem of a processor is one of the most complex components, with a complex interplay of on-chip caching, virtual-to-physical memory address translation and distributed memory locations. At the same time, it is performance-critical. Therefore, most memory schemes are implemented/accelerated in hardware, such as cache coherence, address translation and routing memory operations to the correct location.

Memory compression adds additional complexity because of the extra decompression operation and the larger granularity (compressed pages versus individual cache line accesses). Hence its implementation in software (in the OS). Because of this larger complexity and the sensitivity to potential errors, we aim to minimize the impact of our novel transparent decompression scheme on the current compressed memory implementations (e.g., ZSWAP) by reusing existing infrastructure as much as possible.

Our first observation is that reading compressed data is less complex than writing to compressed data, because the latter requires a recompression of the data. At the same time, read operations are more performance-critical (cores wait for data) and also more common in most applications. Accordingly, under embodiments of the OS-transparent compression schemes disclosed herein, only read operations are supported in an OS-transparent manner. Write operations follow the conventional compression mechanism (e.g., ZSWAP/ZRAM for Linux-based systems).

Second, we observe that we can make use of on-chip caching to hold the decompressed data, rather than moving the data to uncompressed DRAM. This makes a read to compressed data less complex and reduces the pressure on DRAM space available for decompression. Current last-level caches (LLCs) are relatively big (hundreds of MB for Xeons®) and can absorb many decompressed pages without impacting the application performance. Furthermore, if there are multiple accesses to the same page, they mostly occur relatively close to each other in time, i.e., before the page is evicted from cache. In many cases, there is no need to have a backup of the decompressed data in DRAM for read-only data. If a certain page does have reuse beyond the cache capacity, the OS can decide to put it in decompressed DRAM permanently.

### Transparent Decompression

Before explaining the transparent decompression scheme, we define a new address space and translation table to enable transparent decompression.

### Compressed Address Space

Our novel scheme does hardware-only decompression (without OS intervention) for reading compressed data without moving the decompressed page to DRAM (so not requiring any updates to the page table (PT), which is still under control of the OS). Read accesses to compressed data should therefore not generate a page fault, which means that their pages should be mapped in the PT. To that end, we define a new address space, the compressed physical (PHYS_C) space. It contains addresses to compressed data as if these data were not compressed: a byte address maps to a byte in the uncompressed data. Because the data is in fact compressed, these addresses do not directly point to actual locations on the DRAM device, but they are used by the cores to request data from the compressed memory space.

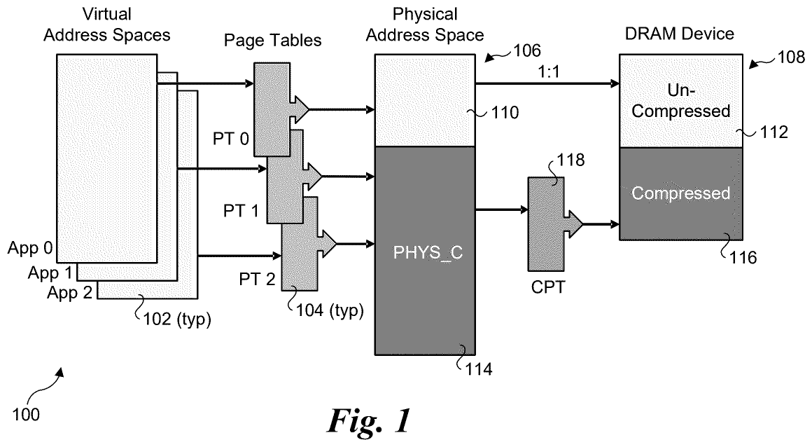

FIG. 1 shows an architecture 100 illustrating selective components of the OS transparent decompression scheme, according to one embodiment. Architecture 100 includes virtual address spaces 102, page tables 104, a physical address space 106, and a DRAM device 108. There is a virtual address space 102 per process, which uses its page table to translate to physical addresses in physical address space 106. As illustrated three virtual address spaces 102 are depicted for respective processes (e.g., applications), labeled App 0, App 1, and App 3, observing that in practice an application may have multiple processes, each of which would be allocated a separate virtual address space. Each of these virtual address spaces will be mapped to pages in physical address space 106 using respective page tables 104, labeled PT 0, PT 1, and PT 2.

The physical address space 106 of a processor that supports transparent decompression is split into two distinct partitions indexed by the most significant (MS) bits of the physical address. The first partition is conventional physical address space 110, i.e., the addresses map directly to a location in uncompressed memory 112 on DRAM device 108, also referred to as “plain” DRAM. The second partition is the PHYS_C space 114, which requires another translation to locate compressed data 116 on memory device 108 and a decompression to obtain the data of the cache line that the core is requesting. We call this secondary translation level the compressed page table (CPT) 118.

The CPT is maintained by the OS, and in one embodiment is stored on a fixed location in memory with a fixed organization, similar to conventional PTs. This enables a hardware CPT walker to translate PHYS_C addresses to the location of the compressed page in memory, similar to the hardware PT walker that is common in current processors.

### Transparent Decompression Scheme

Address space setup: A user (or hypervisor) needs to configure how much memory space is reserved for plain DRAM and for compressed DRAM; in one embodiment this configuration is performed at boot time. The plain DRAM partition determines the conventional physical address space. The exact compressed physical address space size is not known beforehand, because we do not know the compression factor of the data that will be allocated. This is not an issue, because PHYS_C addresses do not point to actual device locations and the OS can assign PHYS_C addresses as long as there is space in the compressed partition.

Allocation & migration: The OS is still responsible for allocating and migrating data to the plain or compressed DRAM space. When allocating/migrating a page to compressed space, the OS generates a PHYS_C address in the compressed physical space, adds the PHYS_C to the conventional PT with a read-only flag, compresses the page (using software or a hardware accelerator), allocates the compressed page to compressed memory and adds the PHYS_C to device address in the CPT.

Read request: When a core issues a read request to the compressed partition, the virtual address is first translated to the PHYS_C address using conventional PT (and TLBs). If the requested cache line is cached on-chip (local cache or shared LLC), it is fetched from cache like an uncompressed access.

Decompression only needs to be done when the request misses in all cache levels. In that case, the request reaches the memory controller (MC), where it is detected that it belongs to the compressed partition (using the MS bits of the physical address). The HW CPT walker then looks up the device address of the compressed page and directs the decompress accelerator to decompress that page, puts the decompressed page in its entirety in the LLC (indexed using its PHYS_C addresses), and sends the requested cache line back to the core. The decompressed page only lives in cache, there is no migration to plain DRAM (which would require a change in the PT and thus involvement of the OS). If a cache line of the decompressed page is evicted from the caches before it is requested by a core, the whole page needs to be decompressed again, but given the large size of the LLC and the observation that most reuse occurs within the caches, this should be infrequent.

Write request: When a core issues a write request to compressed space, it will also pass through the PT/TLB and cause a page fault, because the entry is marked read-only (even if the cache line is cached locally, the page fault occurs). The OS page fault handler recognizes the address as a compressed space address (as opposed to a write to a regular read-only page, which should cause an exception) and resorts to the normal ZRAM/ZSWAP operation: the page is decompressed, put into plain DRAM and the PT is adapted to map the virtual address to a normal DRAM physical address with write permissions. Additionally, it flushes all TLB entries and cache lines that use the previous PHYS_C address.

The embodiments disclosed herein do not support OS-transparent writes to compressed pages, because that requires re-compressing the data, with the possibility that the newly compressed content is larger than the old compressed content, and the page needs to be remapped in compressed space. Instead, we rely on the background demotion policy of the OS that puts the page back in compressed space once it is not touched anymore, performing the compression and mapping in the OS.

### Hardware Additions

An important addition is the CPT and hardware to walk this table and initiate a decompression on the resulting address. A version of the CPT is already maintained by the OS in the conventional schemes, but is not in a fixed standard format on a fixed address in memory. There is only one CPT across the system, compared to one PT per process, as shown in FIG. 1 and discussed above. The CPT is indexed by a PHYS_C address, which has a smaller address space than the virtual address space. Furthermore, PHYS_C addresses are assigned by the OS, which can be made consecutively to densely fill the CPT. The CPT is therefore significantly less complex than the PT and can potentially be implemented as a single table indexed by the page bits of the PHYS_C address.

In one embodiment specialized decompressors are implemented in hardware close to the MCs for transparent decompression in addition to existing hardware supporting conventional compression/decompression (such as IAAs) for OS-directed compressions and decompressions. Part of the CPT can also be cached on-chip to speed up the translations, similar to the conventional TLBs. An important difference is that this cache should be kept only at the MCs (or otherwise not part of the CPU core) as the cores do not know about the CPT translations. In some embodiments, the cache is embedded in the memory controller, while in other embodiments the cache is located proximate to the memory controller.

The OS-transparent decompression scheme also requires software changes in the OS. The operating system needs to implement the concept of PHYS_C addresses, add them in the PT and maintain the CPT. Compressed pages should be marked as such in the PT, such that a write to a compressed page generates a page fault. (The R/W bit cannot be reused for this purpose because there might be read-only data in compressed space that should cause an actual access violation exception when written to). The page fault handler should correctly interpret writes to compressed space events, e.g., turning them into page migrations. Background migration processes may still be supported, but preferably be adapted to the new scheme, e.g., less aggressively demoting pages and moving write-intensive and beyond-cache reuse pages to plain DRAM.

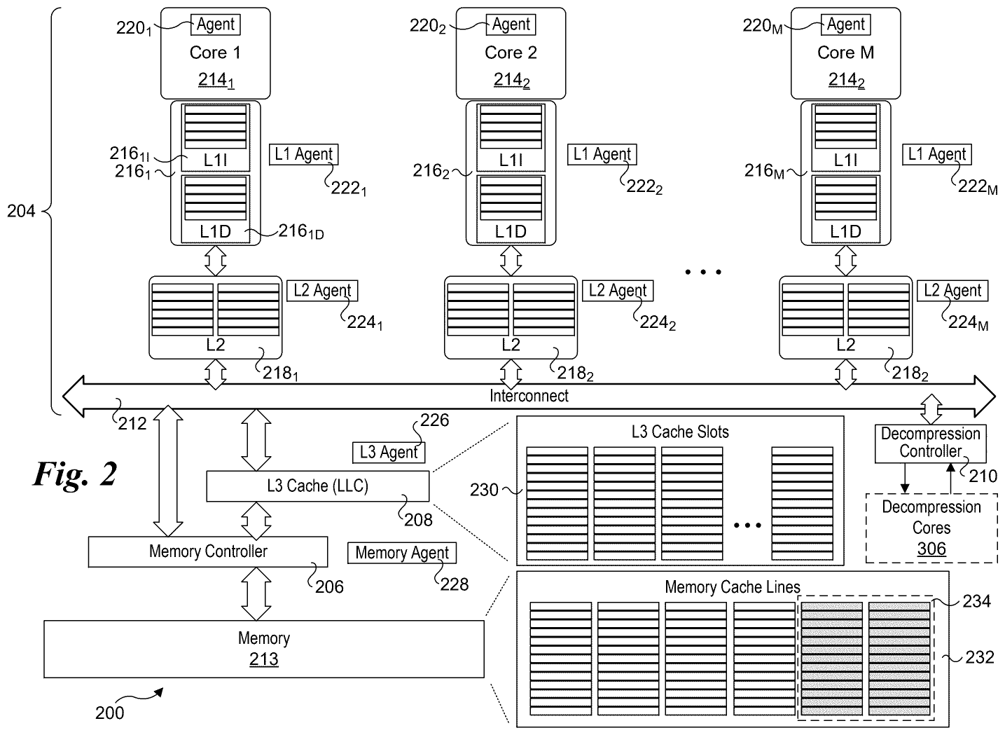

FIG. 2 shows selected hardware components of an exemplary computing platform 200. The hardware components include a CPU having a core 204 coupled to a memory controller 206, a last level cache (LLC) 208 and a decompression controller 210 via an interconnect 212. In some embodiments, all or a portion of the foregoing components may be integrated on a System on a Chip (SoC). Memory controller 206 is configured to facilitate access to system memory 213, which will usually be separate from the SoC. For example, system memory may comprise one or more memory devices supporting one or more memory standards, such as DRAM DIMMs (Dual Inline Memory Modules) having standardized form factors.

CPU core 204 includes M processor cores 214, each including a respective local level 1 (L1) cache 216 and a local level 2 (L2) cache 218 (the cores and the L1 and L2 caches 216 and 218 are depicted with subscripts indicating the core they are associated with, e.g., 216₁ and 218₁ for core 214₁). Optionally, the L2 cache may be referred to as a “middle-level cache” (MLC). As illustrated in this cache architecture, an L1 cache 216 is split into an L1 instruction cache 216_{I} and an L1 data cache 216_{D} (e.g., 216_{1I} and 216_{1D} for core 214₁).

Computing platform 200 employs multiple agents that facilitate transfer of data between different levels of cache and memory. These include core agents 220, L1 agents 222, L2 agents 224, an L3 agent 226, and a memory agent 228. The L1, L2, and L3 agents are also used to affect one or more coherency protocols and to perform relating operations, such as snooping, marking cache line status, cache eviction, and memory writebacks. L3 agent 226 manages access to and use of L3 cache slots 230 (which are used to store respective cache lines). Data is also stored in memory 213 using memory cache lines 232. Memory cache lines that are part of the compressed partition are depicted as memory cache lines 234 and are used to store compressed data.

For simplicity, interconnect 212 is shown as a single double-ended arrow representing a single interconnect structure; however, in practice, interconnect 212 is illustrative of one or more interconnect structures within a processor or SoC, and may comprise a hierarchy of interconnect segments or domains employing separate protocols and including applicable bridges for interfacing between the interconnect segments/domains. For example, the portion of an interconnect hierarchy to which memory and processor cores are connected may comprise a coherent memory domain employing a first protocol, while interconnects at a lower level in the hierarchy will generally be used for IO access and employ non-coherent domains. The interconnect structure on the processor or SoC may include any existing interconnect structure, such as buses and single or multi-lane serial point-to-point, ring, torus, or mesh interconnect structures (including arrays of rings or torus).

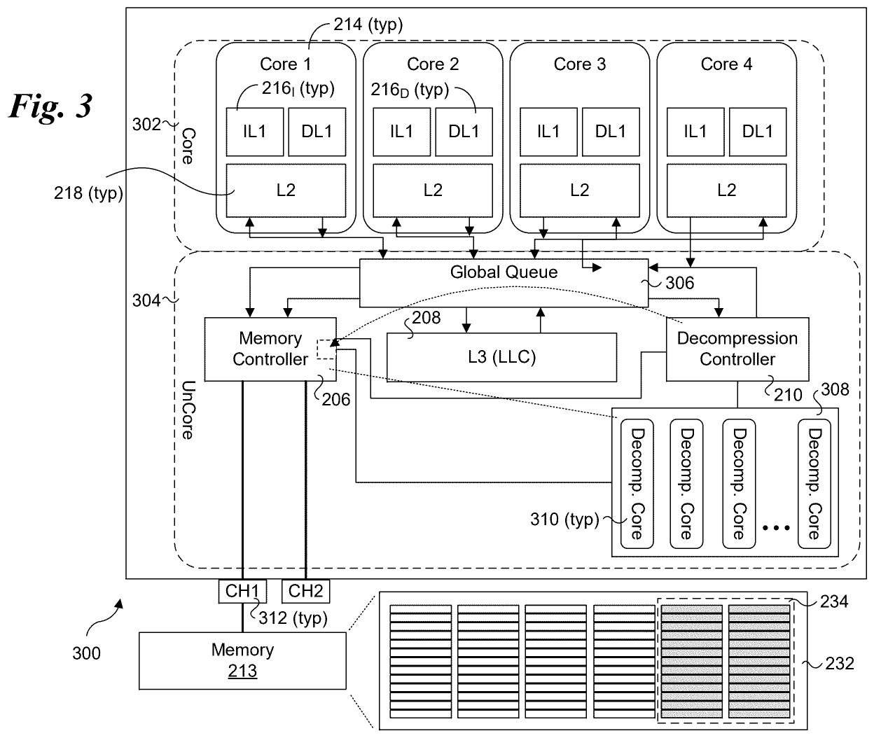

FIG. 3 shows an SoC 300 implementing a memory coherency architecture employed by the embodiment of FIG. 2. Under this and similar architectures, such as employed by some Intel® and AMD® processors, the L1 and L2 caches are part of a coherent memory domain under which memory coherency is managed by coherency mechanisms in the processor core 302. As in FIG. 2, each core 214 includes an L1 instruction (IL1) cache 216I, and L1 data cache (DL1) 216D, and an L2 cache 218. In some embodiments L2 caches 218 are non-inclusive, meaning they do not include copies of any cachelines in the L1 instruction and data caches for their respective cores. As an option, L2 may be inclusive of L1, or may be partially inclusive of L1. In addition, L3 may be inclusive of L1 and/or L2 or non-inclusive of L1/L2. Under another option, L1 and L2 may be replaced by a cache occupying a single level in cache hierarchy.

Meanwhile, the LLC is considered part of the “uncore” 304, wherein memory coherency is extended through coherency agents (e.g., L3 agent 226 and memory agent 228). As shown, uncore 304 (which represents the portion(s) of the SoC circuitry that is external to core 302) includes memory controller 206 coupled to external memory 213 and a global queue 306. Global queue 306 also is coupled to an L3 cache 208, and decompression controller 210. Memory controller 206 includes memory device interface circuitry comprising one or more memory channels (CH) 312. In some embodiments, a memory device, such as a DIMM may include input/output (I/O) circuitry for two memory channels, while other memory devices may provide I/O circuitry for a single memory channel.

As is well known, as you get further away from a core, the size of the cache levels increase, but so does the latency incurred in accessing cachelines in the caches. The L1 caches are the smallest (e.g., 32-80 KiloBytes (KB)), with L2 caches being somewhat larger (e.g., 256 KB to 2 MegaBytes (MB)), and LLCs being larger than the typical L2 cache by an order of magnitude or so (e.g., 30-100+MB). Of course, the size of these caches is dwarfed by the size of system memory (on the order of GigaBytes of even TeraBytes for some servers). Generally, the size of a cacheline at a given level in a memory hierarchy is consistent across the memory hierarchy, and for simplicity and historical references, lines of memory in system memory are also referred to as cache lines even though they are not actually in a cache. It is further noted that the size of global queue 306 is generally quite small, as it is designed to only momentarily buffer cachelines that are being transferred between the various caches, memory controller 206, and decompression controller 210.

Uncore 304 further includes a decompression block 308 comprising a plurality of decompression cores 310 coupled to decompression controller 210. Decompression cores 310 may also be referred to as decompression accelerators. Decompression cores 310 comprise circuitry for performing decompression operations on compressed data accessed from memory 213. Decompression controller 210 is used to control access to decompression cores 310. As further shown in FIG. 3, as an alternative to having a separate circuitry block for decompression controller 210, circuitry for implementing the functionality for a decompression controller may be included as part of memory controller 206. As yet another option, both a decompression controller and decompression cores 310 may be implemented as part of memory controller 206.

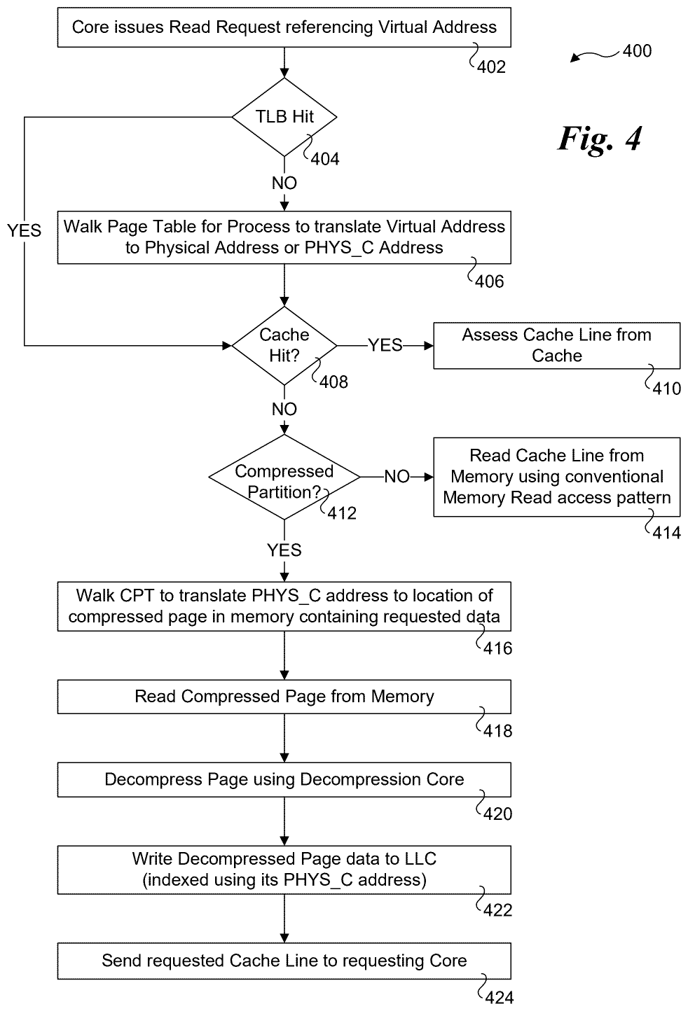

FIG. 4 shows a flowchart 400 illustrating operations and logic perform for a Read request to access data. The process begins in a block 402 with a core issuing a Read request referencing a virtual address of a requested cache line. Rather than use physical memory with physical addressing, operating systems utilize virtual memory with virtual addressing. However, since the memory devices themselves utilize physical addressing, there needs to be a translation from the virtual address of the cache line to the physical address of the cache line. Coherent cache architectures employ Translation Look-aside Buffers (TLBs) that contain page-table entries that map virtual addresses to physical addresses. A TLB may be implemented as a content-addressable memory (CAM). The CAM search key is the virtual address, and the search result is the physical address. If the requested virtual address is present in the TLB, the CAM search yields a match quickly and the retrieved physical address can be used to access memory. This is called a TLB hit.

As shown in a decision block 404 a determination is made to whether there is a TLB hit. For some cache designs, there may be multiple TLBs that are searched. If there is a hit for any of the TLBs, the answer to decision block 404 is YES and the physical address of the cache line is determined using a virtual-to-physical address translation. For example, the physical address may be an address offset from the start of a physical page address for a page table entry in a TLB. The physical address is then used to determine whether the cache line is present in one of the cache levels (L1, L2, or L3). As depicted by a decision block 408, if the cache line is present in a cache the result is a cache hit, and the cache line is accessed from the cache in a block 410.

For illustrative purposes, the TLB hit and cache hit approach shown here is a simplified representation of how a cache line that is cached on-chip (in a local L1/L2 cache or shared LLC) is accessed. Well-known operations such as snoops and the like are not shown for simplicity, but will be understood by those skilled in the art to be used in accordance with the coherent memory architecture of a given system design.

If there is not a TLB hit, the logic proceeds to a block 406 where the page table for the process (requesting the cache line) is identified and walked to translate the virtual address to a physical address or PHYS_C address. This uses the conventional page table walker implemented by existing operating systems, where the processID or virtual address may be used to identify the applicable page table (for the process) to walk. Block 406 returns a physical address corresponding to the physical address of the cache line in plain DRAM or a PHYS_C address used for accessing a cache line in the compressed partition.

The physical address or PHYS_C address is then used to determine whether the cache line is present in an L1, L2, or L3 cache. If there is a cache hit, the cache line is access from the cache in block 410, as before. If there is a cache miss, the answer to decision block 408 is NO and the logic proceeds to a decision block 412 to determine whether the cache line is in the compressed partition. In one embodiment the memory controller utilizes the most significant (MS) bits of the physical address or PHYS_C address to determine with the cache line is located in the compressed partition. If the answer is NO, the cache line is in plain (uncompressed) memory, and the cache line is read from the applicable memory device using a conventional memory read access pattern, as depicted in a block 414.

If the cache line is in the compressed partition, the answer to decision block 412 is YES and the logic proceeds to a block 416 in which the CPT is walked by the memory controller to translate the PHYS_C address to get the location of the compressed page in memory containing the requested data in compressed form. This translation will identify the applicable memory device and the location of the compressed page table in that memory device. For a memory controller supporting multiple memory channels, the memory controller will also identify what memory channel is used to access the memory device. The entire compressed page is then read from memory in a block 418, and decompressed using a decompression core (or decompression accelerator) in a block 420. Rather than writing the decompressed data to uncompressed system memory (plain DRAM), in a block 422 the decompressed page data are written to the LLC as new cache lines and indexed using the PHYS_C address. The process is completed in a block 424 by returning the requested cache line to the requesting core using a conventional LLC access pattern. For example, in one embodiment cache agents for the LLC and L1/L2 caches copy the cache line from the LLC to the L2 cache and the L1 Instruction cache or L1 Data cache. Under other cache architectures, the cache line may be copied to the L1 Instruction cache or L1 Data cache without copying the cache line to the L2 cache.

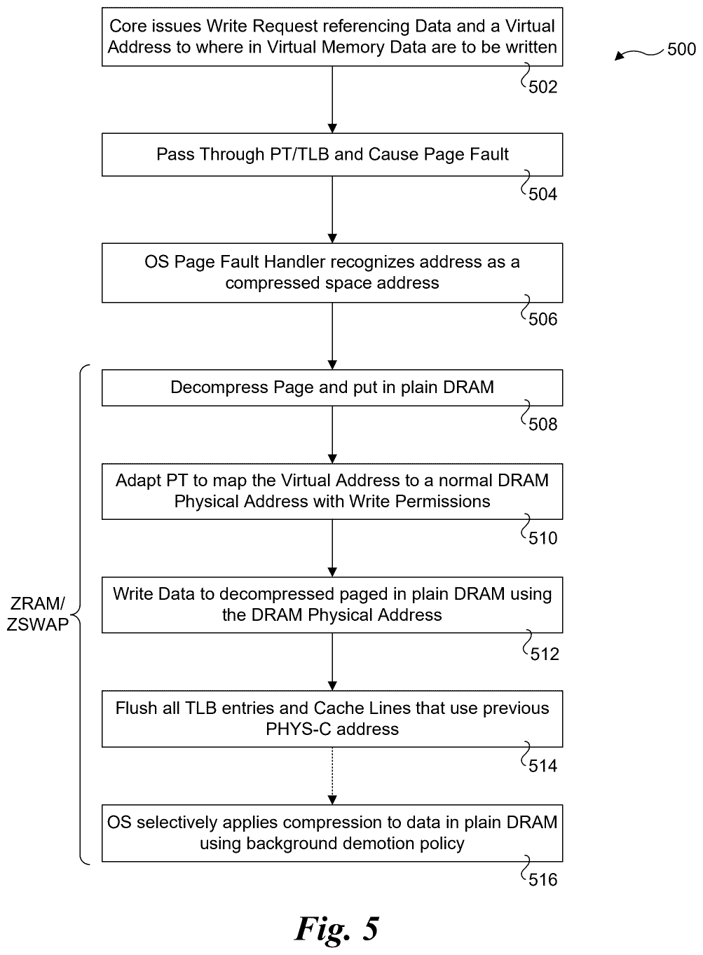

FIG. 5 shows a flowchart 500 illustrating operations performed to service a memory Write request that is to be written to memory in the compressed partition. In a block 502 a core issues a Write request referencing data and a virtual address identifying where in virtual memory the data are to be written. In a block 504 the request will pass through the PT/TLB processing and cause a page fault, because the entry is marked read-only (even if the cache line is cached locally, the page fault occurs). In a block 506 the OS page fault handler recognizes the address as a compressed space address (as opposed to a write to a regular read-only page, which should cause an exception) and initiates the memory Write to the compressed partition using the normal ZRAM/ZSWAP operation. This includes decompressing the page and putting the page in plain DRAM, and adapting the PT to map the virtual address to a normal DRAM physical address with write permissions, as shown in blocks 508 and 510. In a block 512, the data are written to that DRAM physical address in plain DRAM. In a block 514 the TLB entries and cache lines that use the previous PHYS_C address are flushed. Subsequently, the operating system may selectively apply compression to data in plain DRAM using a background demotion policy, as shown in a block 516.

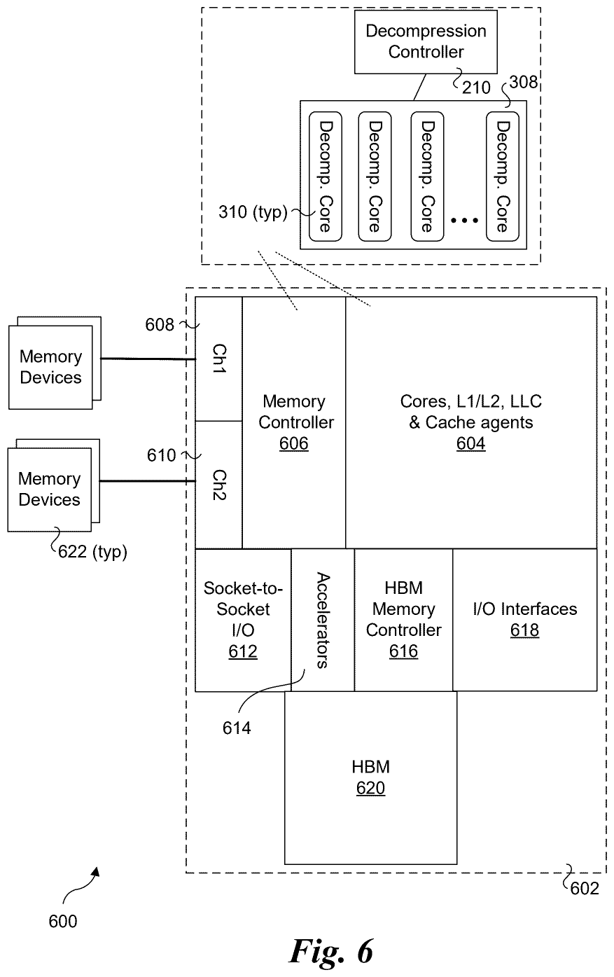

FIG. 6 shows a system 600 including a System-on-Package (SoP) 602. SoP 602 includes a block or tile 604 including multiple cores, L1/L2 caches, an LLC, and cache agents, a memory controller 606 including memory channels 608 and 610, a socket-to-socket I/O interface 612, accelerators 614, a high bandwidth (HBM) memory controller 616, an I/O interfaces block 618 and HBM 620. Each of memory channels 608 and 610 is coupled to one or more memory devices 622. As depicted at the top of FIG. 6, decompression controller 210 and decompression cores or accelerators 310 in decompression block 308 may be integrated on memory controller 606 or on block or tile 604.

In one embodiment accelerators 614 include a plurality of decompression accelerators and compression accelerators, which are separate from decompression cores or accelerators 310. In a non-limiting example, accelerators 614 may be used for software-controlled compression and decompression, such as implemented using ZRAM and ZSWAP. In some embodiments accelerators 614 represent accelerators associated with one of more of Intel® IAA, QAT (QuickAssist Technology), and/or DLB (Dynamic Load Balancer).

Memory devices 622 represent volatile memory. Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

Memory devices 622 are representative of either memory chips supporting on or more of the foregoing standards and/or packaged memory devices including such memory chips, such as DIMMs, SODIMMs (Small Outline DIMMs) and CAMM (Compression Attached Memory Modules) devices. Generally, DIMMs, SODIMMs and CAMM devices will be installed in or attached to mating connectors on a system board or the like in which an SoC or SoP is installed.

HBM 620 is representative of existing and future HBM memory devices supporting one or more of HTM, HBM2, HBM3, and/or HBM4. HBM memory may be tightly coupled with other circuitry in an SoP package, such as using a stacked 3D architecture or a tile or chiplet architecture. For example, all the circuit blocks/tiles shown for SoP 602 except for HBM 620 may comprise an SoC or the like, with HBM 620 coupled to the SoC.

Socket-to-Socket I/O interfaces 612, which are optional, are used to support socket-to-socket communication in a multi-socket platform. Non-limiting examples of multiple socket platforms may include 2 sockets, 4 sockets, or more sockets. Under the terminology “socket” used here, an instance of SoP 602 would be installed in a respective socket on a system board or the like or could be directly mounted to the system board. In the art, the term “socket” in a multi-socket platform refers to a processor, SoC, or SoP whether the processor, SoC, or SoP is installed in a socket or mounted to a system board without a socket. When there are 4 or more sockets, the socket-to-socket communication paths may be arranged in a daisy-chain, a daisy-chain with cross connections and/or variations thereof.

The I/O interfaces in I/O interface block 618 are generally illustrative of I/O interfaces configured in accordance with one or more I/O standards. This includes any type of I/O interface, such as but not limited to Peripheral Component Interconnect express (PCIe), Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The following examples pertain to additional examples of the teachings and principles disclosed herein.
Example 1. An example method can be implemented on a computing platform including a processor having multiple cores and coupled to system memory comprising one or more memory devices and hosting an operating system. A physical address space for the system memory is partitioned to include an uncompressed partition in which data are stored without compression and a compressed partition in which compressed data are stored. In response to a first memory Read request for first data issued by a core, a determination is made to whether the first data are stored in the compressed partition. When the first data are determined to be stored in the compressed partition, the first data are read in a compressed form from a memory device on which the compressed form of the first data resides, decompressed, and the decompressed first data are returned to the core issuing the first memory Read request. The method is performed without generating an operating system page fault and the decompressed first data are not written to the uncompressed partition.
Example 2: The method of claim 1, wherein reading of the first data in compressed form, decompressing the read data and returning the decompressed data to the core issuing the first memory Read request is performed in a manner transparent to the operation system.
Example 3. The method of claim 1 or claim 2, wherein the determination that data are stored in the compressed partition is made by hardware logic on the processor.
Example 4. The method of any of the preceding examples, wherein the processor includes one or more decompression cores or decompression accelerators, and a decompression core or decompression accelerator is used to decompress the first data.
Example 5: The method of any of the preceding examples further including defining a physical address space for the compressed partition as a compressed physical space containing addresses to compressed data as if those data were not compressed where a byte in the compressed physical space maps to a byte in uncompressed data. For each of one or more page tables (PTs), mapping for virtual addresses of memory pages in an uncompressed partition in the physical address space to physical addresses of those memory pages and maintained along with mappings for virtual addresses of memory pages in the compressed partition to compressed physical space addresses for those memory pages.
Example 6. This example extends the method of example 5 by maintaining a Compression Page Table (CPT) containing a plurality of entries, each entry mapping a compressed physical space address for a compressed page to a location on a memory device at which the compressed page is stored.
Example 7. The method of example 6, wherein the first memory Read request issued by the core references a virtual address of the first data. A PT is walked to identify a compressed physical space address of a compressed page associated with the virtual address of the first data, and the CPT is walked to locate an entry containing the compressed physical space address for the compressed page to identify a memory device and location on the memory device where the compressed page is stored.
Example 8. The method of any of the previous examples, wherein the processor includes a first level (L1) cache and a second level (L2) cache for the core and a last level cache (LLC). Without use of the operating system, the compressed page of data including the first data are read from the memory device, decompressed to obtain a decompressed page of data, and the decompressed page of data is cached in the LLC.
Example 9. The method of example 8, wherein in response to a second memory Read request for second data issued by the core, wherein the first data and second data are stored in the compressed page of data, the second data are detected to be cached in the decompressed page of data in the LLC. The second data are then copied from the LLC to the L1 cache for the core.
Example 10. The method of example 9 wherein a physical address space for the compressed partition is defined as a compressed physical space containing addresses to compressed data as if these data were not compressed where a byte in the compressed physical space maps to a byte in uncompressed data. The decompressed page of data cached in the LLC is indexed by the compressed physical space address for the decompressed page.
Example 11. The method of any of examples 8-10 wherein in response to the core issuing a memory Write request including third data to be written to the compressed page in the compressed partition, the compressed page is decompressed and the decompressed page is written to the uncompressed partition. The third data are written to the decompressed page in the uncompressed partition and cache lines from the LLC containing data for the decompressed page are flushed.

The next set of examples pertain to processors, SoC, and SoP and the like that are configured to implement the methods of any of examples 1-11.
Example 12: A processor is configured to be installed in a computing platform having system memory comprising one or more memory devices and configured to execute instructions associated with an operating system and processes for applications to be run on the operating system. The processor has multiple processor cores including a level 1 (L1) and level 2 (L2) cache, and a last level cache (LLC) shared among the multiple processor cores. The processor also includes a memory controller having an interface comprising one or more memory channels configured to be coupled to one or more of the memory devices when the processor is installed in a computing platform, and a plurality of decompression cores or decompression accelerators. The processor is configured to, in response to a first memory Read request for first data issued by a core executing instructions for a process, determine whether the first data are stored in a compressed partition in a physical address space for the system memory. When the first data are determined to be stored in the compressed partition, the processor reads the first data in a compressed form from a memory device on which the compressed form of the first data resides, decompresses the first data using a decompression core or decompression accelerator, and return the decompressed first data to the core issuing the first memory Read request. The decompressed first data are not written to an uncompressed partition in the physical address space for the system memory.
Example 13. The processor of example 12, wherein the memory read, decompression of compressed data and returning the decompressed first data to the core issuing the memory request are performed without use of the operating system.
Example 14. The processor of example 12, wherein the operations are performed without the operating system issuing a page fault.
Example 15. The processor of any of examples 12-14, further configured to read a compressed page of data in the compressed partition including the first data from the memory device, decompress the compressed page of data using the decompression core or decompression accelerator to obtain a decompressed page of data, and cache the decompressed page of data in the LLC.
Example 16. The processor of example 15, wherein a physical address space for the compressed partition is defined as a compressed physical space containing addresses to compressed data as if those data were not compressed, where each byte in the compressed physical space maps to a byte in uncompressed data. The processor is further configured to receive a compressed physical space address corresponding to the compressed page of data, access a Compressed Page Table (CPT) containing a plurality of entries, each entry mapping a compressed physical space address for a respective compressed page to a location on a memory device at which the respective compressed page is stored, the access identifying an entry matching the compressed physical space address corresponding to the compressed page of data and returning the location on the memory device a where the compressed page is stored, and use the location on the memory device to read the compressed page of data.
Example 17. The processor of example 16, further configured to index the decompressed page of data cached in the LLC by the compressed physical space address.
Example 18. The processor of any of examples 12-17, further configured to, in response to a second memory Read request for second data issued by the core, wherein the first data and second data are stored in the compressed page of data, detect the second data are cached in the decompressed page of data in the LLC, and access a copy of the second data from the LLC and return the copy of the second data to the core.
Example 19. This example may extend the functionality of any of processor examples 12-18. A Compression Page Table (CPT) containing a plurality of entries is maintained by the operating system, with each entry mapping a compressed physical space address for a compressed page to a location on a memory device at which the compressed page is stored. The first memory Read request issued by the core references a virtual address of the first data. The CPT is walked by embedded logic in the processor to locate an entry containing the compressed physical space address for the compressed page to identify a memory device and location on the memory device where the compressed page is stored.
Example 20. The processor of any of examples 12-19 is configured to read the compressed page of data including the first data from the memory device, decompress the compressed page of data to obtain a decompressed page of data, and cache the decompressed page of data in the LLC.
Example 21. The processor of example 20, wherein in response to a second memory Read request for second data issued by the core, wherein the first data and second data are stored in the compressed page of data, the second data are detected to be cached in the decompressed page of data in the LLC. The second data are then copied from the LLC to the L1 cache for the core.
Example 22. The processor of example 20 wherein a physical address space for the compressed partition is defined as a compressed physical space containing addresses to compressed data as if these data were not compressed where a byte in the compressed physical space maps to a byte in uncompressed data. The decompressed page of data cached in the LLC is indexed by the compressed physical space address for the decompressed page.
Example 23. The processor of any of examples 12-22, wherein the decompression cores or decompression accelerators comprise embedded logic in the memory controller.
Example 24. The processor of any of examples 12-23, wherein the processor further includes a plurality of accelerators separate from the plurality of decompression cores or accelerators.
Example 25. The processor of any of examples 12-25 further including a decompression controller coupled to the plurality of decompression cores or accelerators.
Example 26: The processor of example 25, wherein the decompression controller comprises embedded logic in the memory controller.
Example 27. The processor of any of examples 12-26, wherein the processor comprises a System on Chip (SoC).
Example 28. The processor of any of examples 12-26, wherein the processor comprises a plurality of discrete dies, tiles, and/or chiplets that are interconnected.
Example 29. The processor of any of examples 12-26 and 28 wherein the processor comprises a System on Package (SoP).
Example 30. The processor of example 30, wherein the SoP includes at least a portion of the memory devices.

The following examples pertain to systems that may be configured to include the processor of any of examples 12-30.
Example 31. A system including system memory comprising a plurality of memory devices, software comprising executable instructions associated with an operating system and processes for applications to be run on the operating system. The system further includes a processor is configured to be installed in a computing platform having system memory comprising one or more memory devices and configured to execute instructions associated with an operating system and processes for applications to be run on the operating system. The processor has multiple processor cores including a level 1 (L1) and level 2 (L2) cache, and a last level cache (LLC) shared among the multiple processor cores. The processor also includes a memory controller having an interface comprising one or more memory channels configured to be coupled to one or more of the memory devices when the processor is installed in a computing platform, and a plurality of decompression cores or decompression accelerators. The processor is configured to, in response to a first memory Read request for first data issued by a core executing instructions for a process, determine whether the first data are stored in a compressed partition in a physical address space for the system memory. When the first data are determined to be stored in the compressed partition, the processor reads the first data in a compressed form from a memory device on which the compressed form of the first data resides, decompresses the first data using a decompression core or decompression accelerator, and return the decompressed first data to the core issuing the first memory Read request. The decompressed first data are not written to an uncompressed partition in the physical address space for the system memory.
Example 32. The system of example 31, wherein the memory read, decompression of compressed data and returning the decompressed first data to the core issuing the memory request are performed without use of the operating system.
Example 33. The system of example 31, wherein the operations are performed without the operating system issuing a page fault.
Example 34. The system of any of examples 31-33, further configured to issue a second memory Read request for second data via execution of instructions for the process on the core, wherein the first data and second data are stored in the compressed page of data, detect the second data are cached in the decompressed page of data in the LLC; and access a copy of the second data from the LLC and return the copy of the second data to the core.
Examples 35-50. The system of example 31, wherein the system of examples 35-50 respectively include the processor of examples 15-30.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

The operations and functions performed by various components described herein may be implemented by embedded software/firmware running on a processing element, via embedded hardware or the like, or a combination of hardware and software/firmware. Such components may be implemented as software or firmware modules, hardware modules, special-purpose hardware (e.g., application specific hardware, ASICs, DSPs, etc.), embedded controllers, hardwired circuitry, hardware logic, etc. Software/firmware content (e.g., data, instructions, configuration information, etc.) may be provided via an article of manufacture including non-transitory computer-readable or machine-readable storage medium, which provides content that represents instructions that can be executed. The content may result in a computer or platform performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the claims to the precise forms disclosed. While specific embodiments of, and examples are described herein for illustrative purposes, various equivalent modifications are possible within the scope of the claims, as those skilled in the relevant art will recognize.

These modifications can be made in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented on a computing platform including a processor having multiple cores and coupled to system memory comprising one or more memory devices and hosting an operating system, comprising:
partitioning a physical address space for the system memory to include an uncompressed partition in which data are stored without compression and a compressed partition in which compressed data are stored;
in response to a first memory Read request for first data issued by a core,
determining whether the first data are stored in the compressed partition; and
when the first data are determined to be stored in the compressed partition,
a) reading the first data in a compressed form from a memory device on which the compressed form of the first data resides;
b) decompressing the first data; and
c) returning the decompressed first data to the core issuing the first memory Read request,
wherein the method is performed without generating an operating system page fault and wherein the decompressed first data are not written to the uncompressed partition.

2. The method of claim 1, wherein the determination that data are stored in the compressed partition is made by hardware logic on the processor.

3. The method of claim 1, wherein the processor includes one or more decompression cores or decompression accelerators, and a decompression core or decompression accelerator is used to decompress the first data.

4. The method of claim 1, further comprising:
defining a physical address space for the compressed partition as a compressed physical space containing addresses to compressed data as if those data were not compressed where a byte in the compressed physical space maps to a byte in uncompressed data; and
maintaining, for each of one or more page tables (PTs),
mappings for virtual addresses of memory pages in an uncompressed partition in the physical address space to physical addresses of those memory pages; and
mappings for virtual addresses of memory pages in the compressed partition to compressed physical space addresses for those memory pages.

5. The method of claim 4, further comprising:
maintaining a Compression Page Table (CPT) containing a plurality of entries, each entry mapping a compressed physical space address for a compressed page to a location on a memory device at which the compressed page is stored.

6. The method of claim 5, wherein the first memory Read request issued by the core references a virtual address of the first data, further comprising:
walking a PT to identify a compressed physical space address of a compressed page associated with the virtual address of the first data; and
walking the CPT to locate an entry containing the compressed physical space address for the compressed page to identify a memory device and location on the memory device where the compressed page is stored.

7. The method of claim 1, wherein the processor includes a first level (L1) cache and a second level (L2) cache for the core and a last level cache (LLC), further comprising, without use of the operating system:
reading a compressed page of data including the first data from the memory device;
decompressing the compressed page of data to obtain a decompressed page of data; and
caching the decompressed page of data in the LLC.

8. The method of claim 7, further comprising:
in response to a second memory Read request for second data issued by the core, wherein the first data and second data are stored in the compressed page of data;
detecting the second data are cached in the decompressed page of data in the LLC; and
copying the second data from the LLC to the L1 cache for the core.

9. The method of claim 8, further comprising:
defining a physical address space for the compressed partition as a compressed physical space containing addresses to compressed data as if the compressed data were not compressed where a byte in the compressed physical space maps to a byte in uncompressed data; and
indexing the decompressed page of data cached in the LLC by the compressed physical space address for the decompressed page.

10. The method of claim 7, further comprising:
in response to the core issuing a memory Write request including third data to be written to the compressed page in the compressed partition,
decompressing the compressed page and writing the decompressed page to the uncompressed partition;
writing the third data to the decompressed page in the uncompressed partition; and
flushing cache lines from the LLC containing data for the decompressed page.

11. A processor configured to be installed in a computing platform having system memory comprising one or more memory devices and configured to execute instructions associated with an operating system and processes for applications to be run on the operating system, comprising:
multiple processor cores including a level 1 (L1) and level 2 (L2) cache;
a last level cache (LLC) shared among the multiple processor cores;
a memory controller having an interface comprising one or more memory channels configured to be coupled to one or more of the memory devices when the processor is installed in a computing platform; and
a plurality of decompression cores or decompression accelerators;
the processor configured to,
in response to a first memory Read request for first data issued by a core executing instructions for a process,
determine whether the first data are stored in a compressed partition in a physical address space for the system memory; and
when the first data are determined to be stored in the compressed partition,
a) read the first data in a compressed form from a memory device on which the compressed form of the first data resides;
b) decompress the first data using a decompression core or decompression accelerator; and
c) return the decompressed first data to the core issuing the first memory Read request,
wherein operations a), b), and c) are transparent to the operating system and wherein the decompressed first data are not written to an uncompressed partition in the physical address space for the system memory.

12. The processor of claim 11, further configured to:
read a compressed page of data in the compressed partition including the first data from the memory device;
decompress the compressed page of data using the decompression core or decompression accelerator to obtain a decompressed page of data; and
cache the decompressed page of data in the LLC.

13. The processor of claim 12, wherein a physical address space for the compressed partition is defined as a compressed physical space containing addresses to compressed data as if those data were not compressed, where each byte in the compressed physical space maps to a byte in uncompressed data, further configured to:
receive a compressed physical space address corresponding to the compressed page of data;
access a Compressed Page Table (CPT) containing a plurality of entries, each entry mapping a compressed physical space address for a respective compressed page to a location on a memory device at which the respective compressed page is stored, the access identifying an entry matching the compressed physical space address corresponding to the compressed page of data and returning the location on the memory device a where the compressed page is stored; and
use the location on the memory device to read the compressed page of data.

14. The processor of claim 13, further configured to index the decompressed page of data cached in the LLC by the compressed physical space address.

15. The processor of claim 12, further configured to:
in response to a second memory Read request for second data issued by the core, wherein the first data and second data are stored in the compressed page of data;
detect the second data are cached in the decompressed page of data in the LLC; and
access a copy of the second data from the LLC and return the copy of the second data to the core.

16. A system comprising:
system memory comprising a plurality of memory devices;
software comprising executable instructions associated with an operating system and processes for applications to be run on the operating system;
a processor comprising,
multiple processor cores including a level 1 (L1) and level 2 (L2) cache;
a last level cache (LLC) shared among the multiple processor cores;
a memory controller having an interface comprising one or more memory channels coupled to one or more of the plurality of memory devices; and
a plurality of decompression cores or decompression accelerators;
wherein the system is configured to,
issue a first memory Read request for first data via execution of instructions for a process on a core,
determine whether the first data are stored in a compressed partition in a physical address space for the system memory; and
when the first data are determined to be stored in the compressed partition,
a) read the first data in a compressed form from a memory device on which the compressed form of the first data resides;
b) decompress the first data using a decompression core or decompression accelerator; and
c) return the decompressed first data to the core issuing the first memory Read request,
wherein operations a), b), and c) are transparent to the operating system and wherein the decompressed first data are not written to an uncompressed partition in the physical address space for the system memory.

17. The system of claim 16, further configured to:
read a compressed page of data in the compressed partition including the first data from the memory device;
decompress the compressed page of data using the decompression core or decompression accelerator to obtain a decompressed page of data; and
cache the decompressed page of data in the LLC.

18. The system of claim 17, wherein a physical address space for the compressed partition is defined as a compressed physical (PHYS_C) space containing addresses to compressed data as if those data were not compressed, where each byte in the compressed physical space maps to a byte in uncompressed data, wherein the processor is configured to:
receive a compressed physical space address corresponding to the compressed page of data;
access a Compressed Page Table (CPT) containing a plurality of entries, each entry mapping a compressed physical space address for a respective compressed page to a location on a memory device at which the respective compressed page is stored, the access identifying an entry matching the compressed physical space address corresponding to the compressed page of data and returning the location on the memory device a where the compressed page is stored; and
use the location on the memory device to read the compressed page of data.

19. The system of claim 17, wherein the processor is further configured to index the decompressed page of data cached in the LLC by the compressed physical space address.

20. The system of claim 17, further configured to:
issue a second memory Read request for second data via execution of instructions for the process on the core, wherein the first data and second data are stored in the compressed page of data;
detect the second data are cached in the decompressed page of data in the LLC; and
access a copy of the second data from the LLC and return the copy of the second data to the core.
